(19) United States
(12) Patent Application Publication
(10) Pub. No.: US 2015/0176685 A1
(43) Pub. Date: Jun. 25, 2015

(54) ROTARY ACTUATOR WITH OPTIMISED SPUR PINION AND RACK

(71) Applicant: M/s. ROTEX Manufacturers and Engineers Pvt. Ltd., Dombivali (East) (IN)

(72) Inventors: AJIT KOTHADIA, Dombivali (East) (IN); AMIT SHAH, Dombivali (East) (IN)

(73) Assignee: M/s. ROTEX Manufacturers and Engineers Pvt. Ltd., Dombivali (East) (IN)

(21) Appl. No.: 14/217,487

(22) Filed: Mar. 18, 2014

(30) Foreign Application Priority Data
Dec. 25, 2013 (IN) 4054/MUM/2013

(51) Int. Cl. F16H 19/04

(52) U.S. Cl. CPC F16H 19/04

(57) ABSTRACT

A rotary actuator with optimized spur pinion and rack, pinion and rack of dissimilar materials and rack of weaker material, positively corrected pinion has twelve involute teeth and negatively equally corrected rack has a entire working composite involute profile and elliptical nonworking root profile, thereby improving performance without interference, with reduced vibration and noise.

### FIELD OF THE INVENTION

The invention relates to rotary actuator with spur pinion and rack arrangement. Particularly the invention relates to rotary actuators with optimized pinion and rack arrangement in spur construction. More particularly, the invention relates to rotary actuator with optimized pinion and rack arrangement in spur construction, with 12 teeth pinion and with performance benefits of 12 teeth as well as 16-18 teeth arrangement.

### BACKGROUND OF THE INVENTION

Rotary actuators are used to remotely operate the valves for controlling the flow of fluids. A typical rotary actuator is a device that produces rotary motion from linear motion caused by pressure. Several designs of the actuators are known which convert reciprocating linear motion into bi-directional rotation, U.S. Pat. No. 4,970,944 being one such patent. In such design, linear motion in one direction is caused by injecting pressurized fluid (generally air) which acts on pistons, held at that location by mechanical energy accumulators, like compression springs. While pistons move, they also compress the springs, thereby accumulating energy in them. As the pressure is released, the pistons are made to move back consequent to springs releasing the accumulated energy.

Conversion of linear motion into rotary motion is known to be achieved by pinion and rack arrangement, as is described in patent U.S. Pat. No. 4,142,448, U.S. Pat. No. 4,722,238 and patent publication number EP2347944B1 for such applications.

Use of pinion and rack arrangement in rotary actuators is disclosed in patent U.S. Pat. No. 4,044,631, also patent publication number US2003041598A1.

In pinion and rack arrangement, like in any transmission gear system, the performance of transmission depends on key design factors including pressure angle, tooth profile, that is, shape of the tooth, number of teeth, contact ratio. Many of the key factors are interdependent.

Fundamentally, more number of teeth, which implies lower pressure angle and higher contact ratio, result in smoother and quieter performance, as disclosed in U.S. Pat. No. 4,276,785 as well as U.S. Pat. No. 4,259,875, however, strength of individual teeth and therefore torque bearing capacity is impacted.

Pinion and rack arrangement is deployed both in helical and spur construction. U.S. Pat. No. 4,222,282A discloses a helical type pinion and rack arrangement. Patent publication number EP1731799B1 discloses helical pinion and rack arrangement with less number of teeth consequent to high pressure angle. The invention exploits the characteristic of helical arrangement which invariably results in axial loads, which are desirable in application described in this patent, but not desirable in our application of rotary actuators as the pinion is in floating condition axially.

Text books prescribe higher pressure angle, in order to have less number of teeth. Increase in pressure angle results in tooth becoming narrow and thereby weak at the crest. Another problem of increase of pressure angle is reduction in contact ratio. Undercutting is also prescribed as a method to have combination of low tooth-medium pressure angle without interference. This method, however, weakens the root of the tooth and defeats the basic purpose of reducing number of teeth. Reduction in contact ratio results in noisy power transmission. Also, addendum relief, which is a known method to avoid scuffing, has an adverse effect of reducing conjugate working profile.

Our invention solves above problems and results in benefits to rotary actuator with spur type pinion and rack arrangement, of reduced number of tooth, without change in the pressure angle, where the crest of the teeth is narrowed and the root is thickened increasing the bending strength, still maintaining required contact ratio, thereby resulting in interference free operation with reduced vibrations and noise.

### OBJECTIVE OF THE INVENTION

The objective is to invent a rotary actuator with 12-teeth spur type pinion and rack arrangement which has performance benefits of 12-teeth as well as 16-18 teeth pinion and rack arrangement.

### SUMMARY OF THE INVENTION

This invention discloses a rotary actuator with spur type pinion and rack arrangement with dissimilar materials. Pinion has 12 teeth. Teeth of pinion and rack are provided with addendum correction. Corresponding rack is with composite involute working profile which maintains conjugate action such that performance parameters of the rotary actuator have the advantages of 12 teeth as well as 16-18 teeth pinion and rack arrangement.

The profile of teeth of 12-tooth pinion is positively corrected and profile of corresponding rack is accordingly equally negatively corrected.

Rack being of weaker material, the non-working profile of rack tooth is modified at its root and made elliptical which increases the area of the root section. At the same time, there is no increase of machining or manufacturing cost since rack is integral to piston and is a cast component.

The tip of the rack tooth is given a tangential involute shape forming a composite involute working profile. The cross sectional area at the tip is decreased, which results in increased elastic deformation acting as a shock absorber thereby reduces wearing as well as vibrations. Also, scuffing of pinion tooth is avoided consequently.

### BRIEF DESCRIPTION OF DRAWINGS

FIG. 1 shows cross-sectional view of a rotary actuator with spur type pinion and pair of racks, with pistons integral to corresponding racks.

FIG. 2 gives various nomenclature and terms related to construction of spur type pinion and rack arrangement, which are used in the expressions and formulae.

FIG. 3 shows a spur type pinion and rack arrangement with 12 tooth and consequent interferences, which make 12-tooth version impractical in normal course.

FIG. 4 shows corrections when incorporated in pinion tooth alone.

FIG. 5 shows inventive corrections when incorporated in rack tooth alone.

FIG. 6 shows complete profiles of our optimized with spur type pinion and rack arrangement.

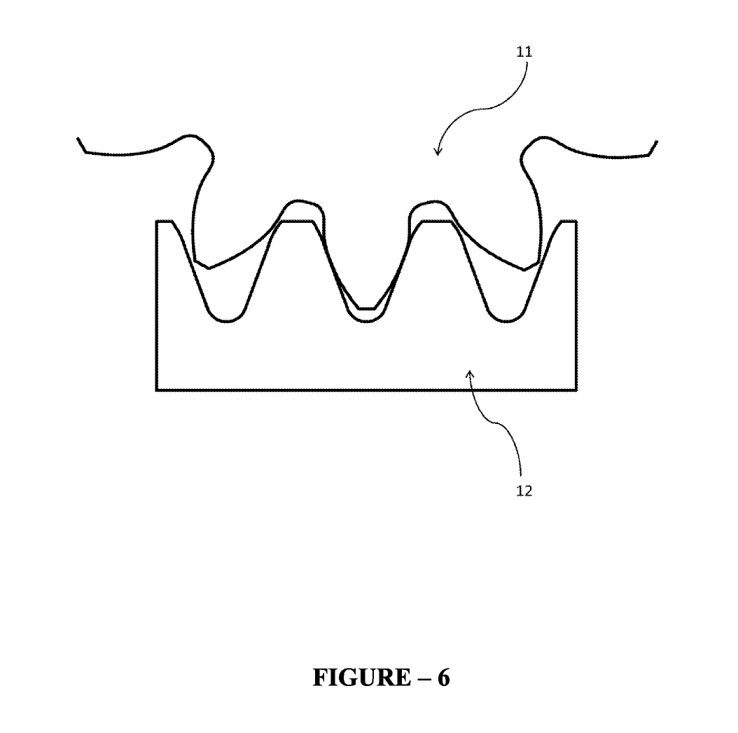

FIG. 7 shows comparative shapes of tooth with different pressure angle.

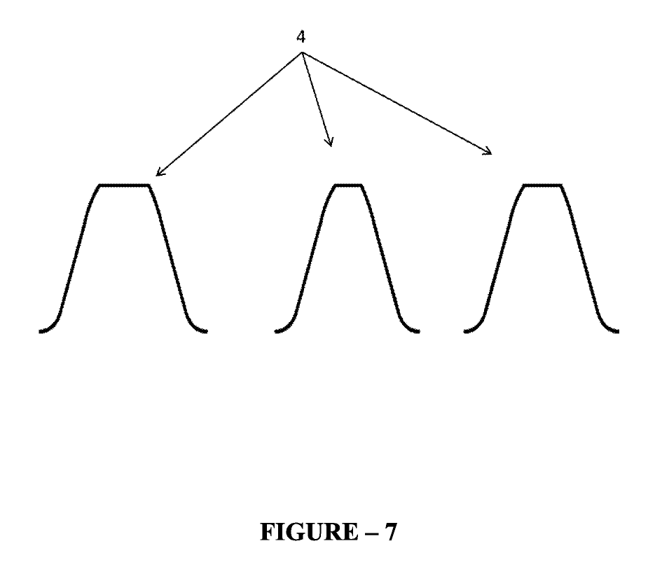

FIG. 8 shows details of strengthening of root of tooth of rack due to elliptical construction at root of tooth of rack.

FIG. 9 illustrates the undesirable wear, known as “scuffing” phenomenon on pinion tooth.

FIG. 10 shows prior art of avoiding scuffing, which is by providing chamfers, resulting in undesirable cusp.

FIG. 11 shows details of inventive composite involute working profile of tooth of rack.

### DETAILED DESCRIPTION OF THE INVENTION

Preferred embodiments of our invention will now be described in detail, with reference to the accompanying drawing. Calculations and comparative analysis is given with respect to 12 teeth verses 16 or 17 teeth spur type pinion and rack arrangement, maintaining pressure angle of 20°.

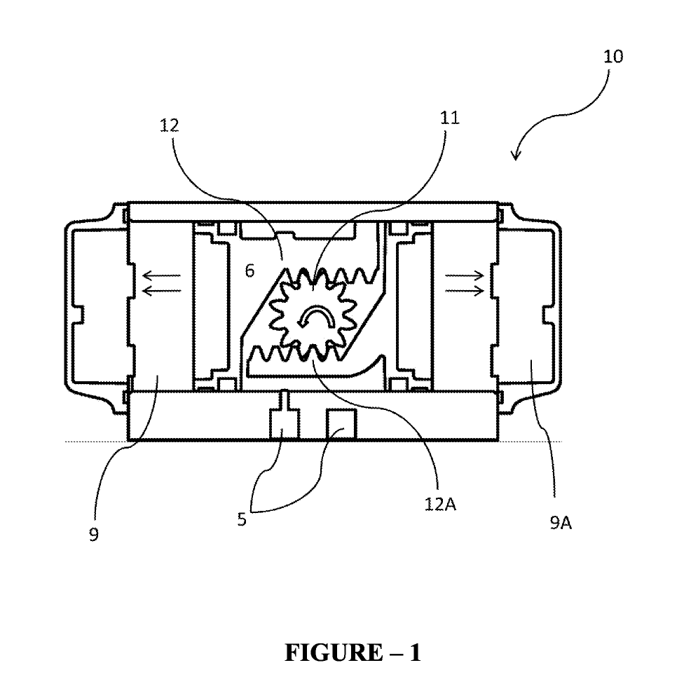

Our invention is a rotary actuator with 12 teeth pinion and rack arrangement, in spur construction, of dissimilar materials. FIG. 1 shows a rotary actuator (10) with pinion (11) and racks (12) and (12A). As the pressure in chamber (6) is made to increase by injecting fluid through orifice (5), pistons (9) and (9A) move outwards and rack (12) and (12A), constructed integrally with the pistons (9) and (9A), likewise move outwards as shown by arrows. Linear motion of racks (12) and (12A) causes rotary motion of pinion (11), in this illustrative situation, in the counter-clockwise direction.

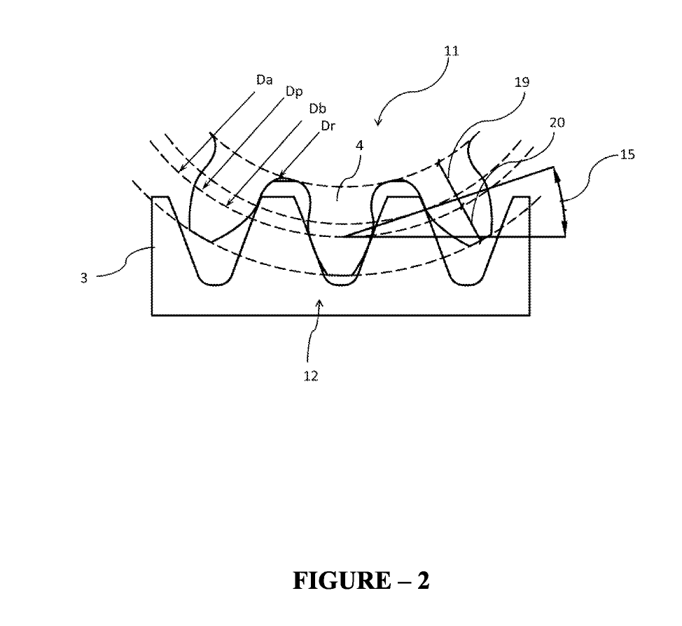

FIG. 2 gives nomenclature and terms related to construction of spur type pinion and rack arrangement. One of the most significant terms to be understood is module (m), which is obtained by dividing Pitch Diameter (Dp) by number of teeth (Z).

In Rack-Pinion Rotary actuator the Pitch Diameter of pinion (also known as pitch circle diameter and commonly abbreviated as PCD) is fixed by the desired torque required to operate the valve (not shown) for which the actuator is deployed. The desired torque is produced by compressed air, which results in producing force, as follows:

Air force F=(π·do²·P)/4

Where
do=diameter of orifice (5)
P=air pressure for operating actuator
   Thus, torque T=F·Dp/2

Where
Dp=Pitch diameter or PCD of pinion

### Therefore

Dp=2T/F

So for given PCD
m=Dp/Zc

Where
Zc=Teeth on pinion to avoid interference
m=Module
   With 16 teeth, module m=Dp/16
   With 12 teeth, module m=Dp/12
   Increase in module={[[16/12]−1}100=33.3%
   Therefore, by reducing number of teeth on from 16 to 12, the module is increased by 33%.

F=[σb]·Y·b·m Bending stress From Lewis Equation

Where
F=Tangential force
[σb]=Bending stress
m=module

$$\begin{matrix}Y = Lewis form factor \\ = π \cdot [ \begin{matrix}0.154 & - 0.912 \text{/} Z\end{matrix} ] pressure angle α = 20 ° and full depth\end{matrix}$$

$$\begin{matrix}b = Face width \\ = Ψ \cdot m\end{matrix}$$

Bending Stress at the Root of the Rack Tooth

(σ_{b})_{rack}=F/(Y·Ψ·m²) keeping Ψ same
(σ_{b})_{rack}α1/m²
Since module increased by 33%
So the bending stress reduction=={1-[1/(1.33)̂2]100=43%
The fatigue bending life is improved by 43%.
Thus, by reducing number of teeth to 12, the fatigue bending life of rack is improved by 43%

For simplification consider static loading on pair of meshing pinion-rack teeth.

The wear load given by
F=Dp·Q·b·k

where
Dp=m·Z_{c} pinion pitch diameter
Q=2i/(i+1)≈2
For Rack-pinion:
Q=Dimensionless number
I=(Gear ratio) very high
b=Ψ·m Face width

$$k = \frac{{[ σ c ]}^{2} \cdot sin α \cdot [ 1 / {E}_{1 +} 1 / {E}_{2} ]}{1.4}$$

Where E₁ and E₂=Modulus of elasticity
Substituting and simplifying

$$( σ c ) = √ \frac{0.7 F}{Zc \cdot Ψ \cdot sin α \cdot [ 1 / {E}_{1 +} 1 / {E}_{2} ] \cdot {m}^{⋀} 2}$$

(σc)_{rack} α1/m
Since module increased by 33%
So the contact stress reduction={1−[1/1.33]100=25%
The fatigue contact life is improved by 25%. Thus, by reducing number of teeth to 12, the fatigue bending life of pinion and rack arrangement is improved by 25%

Various constructional aspects of pinion and rack are interdependent. Known relation between no. of teeth and pressure angle is as follows: Number of teeth to avoid interference

$$Zc \geq \frac{2 a / m}{{Sin}^{2} α}$$

### Where

Zc=Critical number of teeth of smaller gear

a=addendum of pinion or rack

m=module

α=Pressure Angle

For standard gear a=m

$$Zc \geq \frac{2 a}{{Sin}^{2} α}$$

$$\begin{matrix}\_For α = 14 \frac{1}{2} ° & Zc \geq \frac{2}{{Sin}^{2} 14.5} & Zc = 31 \\ For α = 20 ° & Zc \geq \frac{2}{{Sin}^{2} 20} & Zc = 17 \\ For α = 25 ° & Zc \geq \frac{2}{{Sin}^{2} 25} & Zc = 11\end{matrix}$$

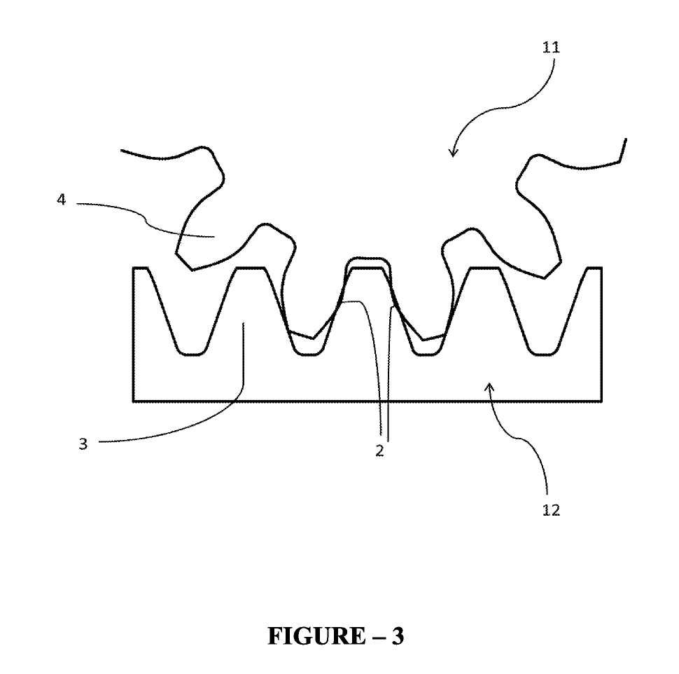

From above, it is clear that pinion and rack having pressure angle (15)=20° and with 12 teeth (i.e. less than 17 teeth) is not a standard combination and shall result into interference (2) during meshing. FIG. 3 shows a pinion and rack arrangement with 12 teeth and consequent interference (2). The effect of interference (2) is usually that during mesh commencement the tip/face of the driver gear digs out the non-involute flank portion of the driven. As numbers of cycles are increased the area of digging extends further in involute profile zone and further destruct the involute profile. The conjugate area of the tooth profile is thereby decreased.

To avoid such interference (2), our inventive steps in the embodiment are described here.

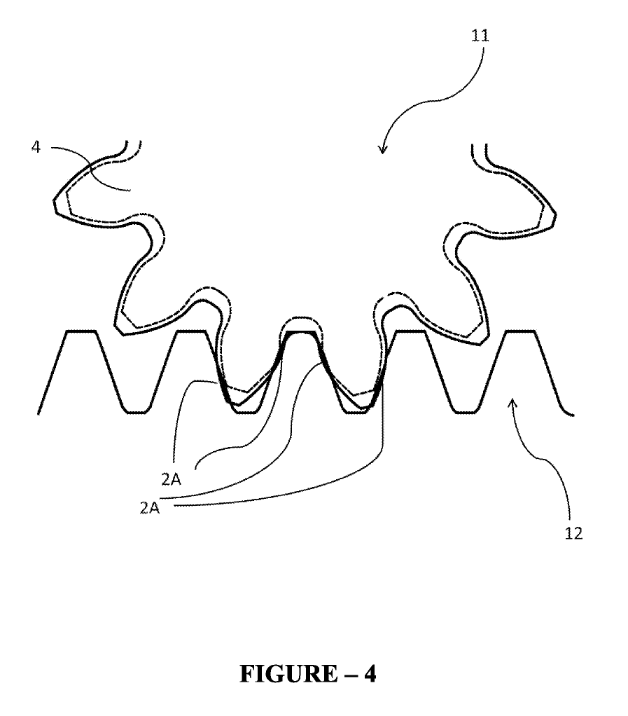

Pinion (11): Addendum (19) of pinion teeth (4) is increased by 0.2 to 0.6 module, keeping total height of the teeth to be the same in terms of multiple of module as in case of 16-18 teeth as well as 12 teeth. This modification effectively outwardly shifts the entire pinion. This effect is diagrammatically shown in FIG. 4 where uncorrected pinion teeth (4) is shown in dotted line and corrected pinion teeth (4) are shown in solid line. Also, this correction results into interferences (2A).

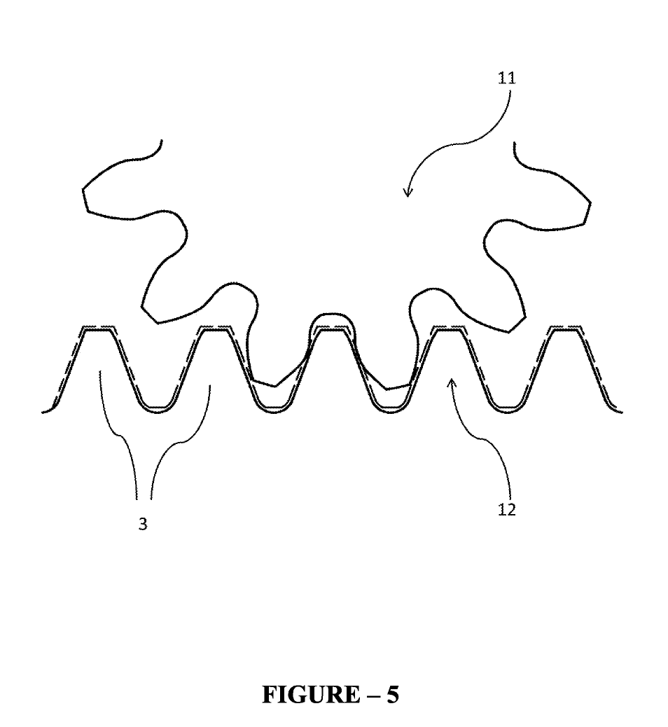

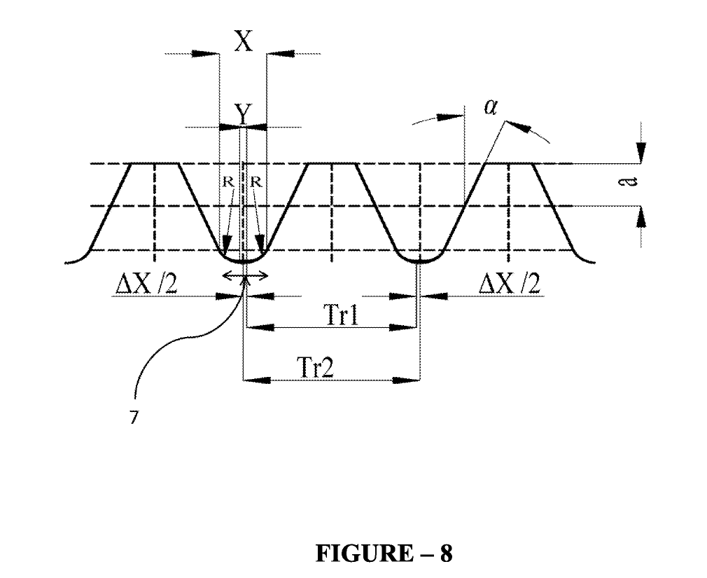

Rack (12): Addendum “a” (FIG. 8) of rack teeth (3) is correspondingly equally reduced by 0.2 to 0.6 module. This modification relatively backwardly shifts the entire rack. This effect is diagrammatically shown in FIG. 5 where uncorrected rack teeth (3) are shown in dotted line and corrected rack teeth (3) are shown in solid line.

Since rack (12) and (12A) in rotary actuator (10) is integral to piston (9) and (9A) respectively, it is made of aluminum or aluminum alloy or equivalent material, commensurate with required performance of piston (9) and (9A). Teeth (3) of rack (12) and (12A) are intrinsically weaker in strength than teeth (4) of pinion (11), which is made of iron or iron alloys. In involute gears, which are deployed in our design, involute curve begins at the base circle with diameter Db as shown in FIG. 2 and extends outward to form the gear tooth profile. Thus, there is no involute inside the base circle with diameter Db, that is, in the zone between base circle (29) with diameter Db and root circle with diameter Dr. At the same time, there is maximum stress in root area (7) of rack. In our design, root area (7) of the teeth of rack (3) is strengthened by providing elliptical arc (26) instead of circular arc (27). This strengthening is arithmetically explained as below, with the aid of FIG. 8:

The standard rack is produced by generation process and the root area (7) has trochoid fillet arc.

With pressure angle (15)=20°,

X=(m/2−2m·tan 20)=0.84306m

The standard trochoid fillet arc radius R=0.38 m
Without trochoid fillet arc the bottom land

Y=X−2R=(X−2×0.38m)=(0.84306−0.76)m=0.08306m

With torchoid arc the root thickness in terms of module is

Tr₁=(π−0.08306)m=3.059m

With single ELLIPTICAL arc, the root thickness is,

Tr₂=2×πm/2=πm=3.142m

Increase in root thickness with elliptical fillet arc

Δx=Tr₂−Tr₁=[(3.142−3.059)m=0.083m

Since the induced bending stress

(σ_{b})α1/t²

% Increase in bending life={1−1/(1+0.083)²}100=14.75%

Thus, elliptical arc (26) provides higher tooth thickness in the neighborhood area of the root and provides around 15% higher bending life

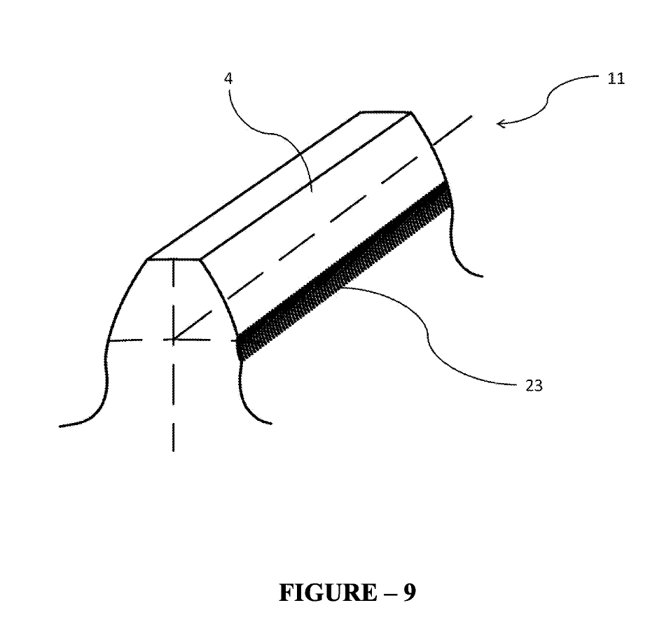

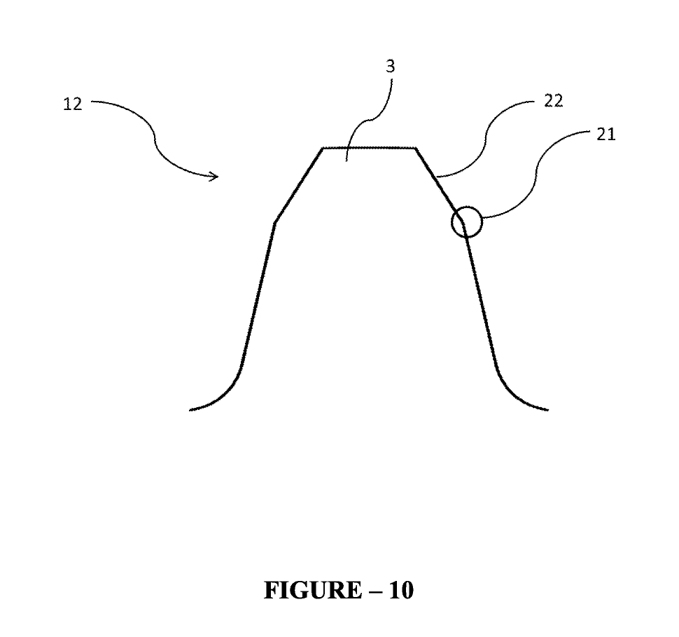

FIG. 9 shows a known problem called “scuffing” (23) on pinion tooth (4) which correspondingly wears out tip of tooth (3) of rack. Known solutions are (a) providing tip relief curve, which is arc of a circle, which results in non-conjugate movement, and interference is not fully avoided, or (b) chamfer (22) in the form of a straight line, which has same drawback (FIG. 10). Additionally, it results in unrounded or sharp line, known as a cusp (21) and therefore increased vibration and noise.

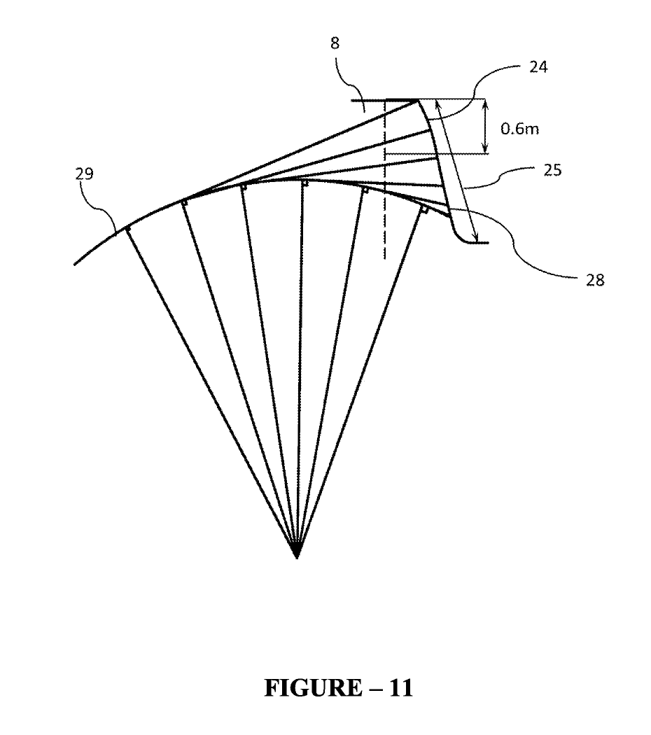

Our inventive solution, which solves the problem of scuffing (23), is by providing involute curve (24) for a height of about 0.6 m of the addendum, at the same time ensuring that width of tip of tooth of rack (8) is 0.4 m or above. The rack profile thus generated is termed composite involute (25), or tangential composite involute, which comprises of straight involute (28) and curved involute (24), meshing so as to be tangential to each other. FIG. 11 describes construction of composite involute (25).

The thus optimized pinion and rack comprises of

1. Positively corrected pinion having
a. Increased addendum
b. Decreased dedendum
Keeping height of pinion tooth unaltered

2. Negatively corrected rack having
a. Reduced addendum
b. Increased dedendum
Keeping height of the tooth unaltered

3. Strengthened root of tooth of rack by use of elliptical profile.

4. Rack tooth of Composite involute.

It is estimated that contact ratio dips marginally consequent to number of tooth reducing from 16-18 to 12, however contact ratio of the invented profile is >1.5 and thus there is no material disadvantage.

Following calculations are to understand change in Contact Ratio, abbreviated as CR:

$$CR = \frac{\begin{matrix}\{ [ √ [ {( m \cdot Zc / 2 + a )}^{2} ] - {( m \cdot Zc / 2 \cdot cos α )}^{2} ] - m \cdot Zc / 2 \cdot sin α \} + \\ ( m / sin α )\end{matrix}}{π \cdot m \cdot cos α}$$

$$CR = \frac{\{ [ √ [ {( Zc / 2 + 1 )}^{2} ] - {( Zc / 2 \cdot cos α )}^{2} ] - Zc / 2 \cdot sin α \cdot \} + ( 1 / sin α )}{π \cdot cos α}$$

### For Zc=16 CR=1.74

For Zc=12 uncorrected CR=1.701

$$CR = \frac{\begin{matrix}\{ [ √ [ {( m , Zc / 2 + m ( 1 + x ) )}^{2} ] - {( m \cdot Zc / 2 \cdot cos α )}^{2} ] - m \cdot Zc / 2 \cdot sin α \} + \\ m ( 1 - x / sin α )\end{matrix}}{π \cdot m \cdot cos α}$$

$$CR = \frac{\begin{matrix}\{ [ √ [ {( Zc / 2 + ( 1 + x ) )}^{2} ] - {( Zc / 2 \cdot cos α )}^{2} ] - Zc / 2 \cdot sin α \} + \\ ( 1 - x / sin α )\end{matrix}}{π \cdot cos α}$$

For Zc=12 correction x=±0.4, CR=1.523
Reduction in contact ratio=12.5%

### Recommended CR=1.5

It is to be noted that several combinations with variation are possible around this embodiment whereby 12 tooth spur type pinion and rack design can be attained with different degrees of compromise, and the description given herein above by no means limits our invention.

By calculations, followed by experimentation, it is established that 12 teeth is the limit of minimum number of teeth for operable arrangement of spur type pinion and corresponding rack arrangement in Rotary Actuators, and which is our invention.

### NOMENCLATURE

| | |
|---|---|
| a = Height of addendum | b = Width of face of tooth |
| CR = Contact Ratio | Db = Base Diameter |
| Dr = Root Diameter | Dp = Pitch Diameter |
| F = Tangential Force | Da = Addendum diameter |
| do = diameter of orifice | m = module |
| P = air pressure for operating actuator | R = radius at root of tooth of rack |
| Tr₁ = width of base of tooth of rack with | x = addendum correction factor |
| circular arc circular arc | α = Pressure angle |
| Tr₂ = width of base of tooth of rack with | σ_{b} = bending stress |
| elliptical arc | σ_{c} = Contact stress |
| X = Top, bottom land of standard rack | Q = Dimensionless number |
| tooth | |
| Y = length of flat land due to circular arc | |
| at root of tooth of rack | |
| Zc = Critical number of teeth on pinion | |
| ψ = b/m | |
| Δx = Tr₂ − Tr₁ | |
| i = Gear ratio | |
| E₁ and E₂ = Modulus of elasticity | |

We claim:

1. A rotary actuator with a spur pinion and rack arrangement comprising of: two pistons, each of the piston integrally connected to a rack, such that linear motion of each of said piston converts into a rotary motion in a pinion, the pinion and the racks being of dissimilar materials, said racks being of lighter and weaker material with respect to said pinion; wherein the improvement comprises said pinion consisting of twelve involute teeth and positively corrected, meshing on said racks of involute teeth and with a root strengthening and equally negatively corrected, and further the racks have a composite involute profile of teeth.

2. The rotary actuator with the spur pinion and rack arrangement as claimed in claim 1) wherein the twelve involute teeth of the pinion are positively corrected by the order of 0.4 times module and the involute teeth of the rack are equally negatively corrected by the order of 0.4 times module.

3. The rotary actuator with the spur pinion and rack arrangement as claimed in claim 1) wherein the root strengthening of involute teeth of the rack is by an elliptical fillet provided in non-working profile of teeth of the rack.

4. The rotary actuator with the spur pinion and rack arrangement as claimed in claim 1) wherein the composite involute profile of teeth of the rack is combination of a curved involute and a straight involute, meshing so as to be tangential to each other, maintaining a width of tip of the teeth of the rack of the order of 0.4 times module.

5. The rotary actuator with the spur pinion and rack arrangement substantially as hereinabove described in the specification with reference to the accompanying drawings.
